(19) United States
(12) Patent Application Publication
(10) Pub. No.: US 2022/0041887 A1
(43) Pub. Date: Feb. 10, 2022

(54) Use of formulations comprising curable compositions based on polysiloxanes

(71) Applicant: Evonik Operations GmbH, Essen (DE)

(72) Inventors: Katrin ROLAND, Essen (DE); Julia Foth, Rheinberg (DE); Laura Genilke, Essen (DE); Simone Schulte, Essen (DE); Christina Janke, Essen (DE)

(73) Assignee: Evonik Operations GmbH, Essen (DE)

(21) Appl. No.: 17/395,616

(22) Filed: Aug. 6, 2021

(30) Foreign Application Priority Data
Aug. 10, 2020 (EP) 20190191.5

(51) Int. Cl. C09D 171/02; C08G 65/26; C08G 65/336; C09D 5/16; C09D 183/04; B05D 1/02; C08G 77/18

(52) U.S. Cl. CPC C09D 171/02; C08G 65/2642; C08G 65/336; B05D 2518/12; C09D 183/04; B05D 1/02; C08G 77/18; C09D 5/1675

(57) ABSTRACT

A formulation contains a curable composition having component A, component B, component C, and component D. Component A may have at least one polysiloxane. Component B may have at least one polyether bearing silyl groups and/or reaction products of a polyether bearing silyl groups with one or more isocyanate-containing compounds. Component C may have at least one catalyst. Component D may have at least one epoxy-functional compound and/or one amino-functional compound. The formulation can be used in a method for coating components that contact process water in an evaporative cooling system, a cooling tower, and/or a wet separator.

### CROSS-REFERENCE TO RELATED APPLICATIONS

This application claims priority to European Patent Application No. 20190191.5, filed Aug. 10, 2020, the content of which is hereby incorporated by reference in its entirety,

### BACKGROUND OF THE INVENTION

### Field of the Invention

This invention relates to the use of formulations comprising curable compositions for coating components that come into contact with process water in evaporative cooling systems, cooling towers and/or wet separators.

### Description of Related Art

Evaporative cooling systems and cooling towers are used to release heat loads, for example from industrial processes, to the environment. These are cooling systems in which the cooling effect resulting from the evaporation of water is utilized. For this purpose, water is guided into an air stream, which can lead to aerosol formation. In spite of the use of droplet separators, water droplets can be entrained from the waste air and get into the environment.

In such cooling systems and also wet separators, favourable reproduction conditions exist for microorganisms (e.g. bacteria, algae, moulds, protozoa), for example moisture, nutrient supply, temperature and light. Among the microorganisms, it is also possible for pathogens, for instance Legionella, to reproduce and get into the environment via the entrained water droplets. These constitute a risk to health since they can cause infectious diseases if inhaled. Projections showed that about 15 000 to 30 000 community-acquired Legionella pneumonia cases per year are to be expected in Germany, some of which may have resulted from evaporative cooling systems.

Biofilms and the surfaces of components of evaporative cooling systems play a central role in the reproduction and spread of microorganisms, especially of Legionella. They form particularly on the water-wetted surfaces of pipelines, heat transferrers, packings and droplet separators.

A standard approach to suppressing germ infestation of cooling towers is the use of biocides. However, the use of biocides is subject to strict legal regulations. For instance, only persons trained to work with the particular biocide are allowed to work with it.

Biofilms consist of water to an extent of roughly 95%. The majority of the dry matter consists of extracellular polymeric substances. In addition, biofilms may contain organic and inorganic particles. The growth of the biofilms is promoted by mineral deposits, soil, sludge deposits and corrosion products.

About 90% of all bacteria in water live within the biofilm since they receive benefits as a result, for example the enrichment of nutrients, the formation of communities (biodiversity, symbiosis).

As well as their hygienic significance, biofilms can also have an adverse effect on the operation of the cooling system: for example, they can lead to perturbations of heat transfer and to deposits in control fittings and measurement cells, and promote corrosion.

Therefore, a delay in or even prevention of biofilm formation in evaporative cooling systems would be highly advantageous both from a hygiene and operational point of view. It would also be desirable to increase the cooling effect.

Evaporative cooling systems and cooling systems are used here as synonyms.

The person skilled in the art is aware of the curable composition based on polysiloxanes from EP 3 461 864, with which the surfaces of ships' hulls, buoys, fishing nets, offshore drilling systems exposed to seawater, are coated in order to reduce fouling or biofouling, namely the adhesion and growth of organisms, for example barnacles (Balanidae), mussels (Bivalvia), sea squirts (Ascidia), bryozoans (Bryozoa), sponges (Porifera), polyps (Hydrozoa), sea anemones (Actinaria), serpulids (Serpulidae), Spirorbis spirorbis, amphipods (Amphipoda), naval shipworms (Teredinidae), green algae, seaweed, sea lettuce, brown algae, red algae. It is assumed here that the substrate surface (ships' hulls, buoys, fishing nets etc.) is “masked” by the formation of a hydrogel and the organisms do not perceive it as a surface.

### SUMMARY OF THE INVENTION

It has been found that, surprisingly, the use of formulations comprising curable compositions according to EP 3 461 864 comprising as
component A at least one polysiloxane,
component B at least one polyether bearing silyl groups and/or reaction products of a polyether bearing silyl groups with one or more isocyanate-containing compounds,
component C at least one catalyst and
component D at least one epoxy-functional compound and/or one amino-functional compound,
   is of excellent suitability for coating components that come into contact with process water in evaporative cooling systems, cooling towers and/or wet separators.

Firstly, the coated components according to the invention reduce the formation of biofilms, and secondly, which was additionally a complete surprise, extend the dwell time of the process water on such components in order to optimize the cooling effect.

The invention also includes he following embodiments:

1. Use of formulations comprising curable compositions comprising as
component A at least one polysiloxane,
component B at least one polyether bearing silyl groups and/or reaction products of a polyether bearing silyl groups with one or more isocyanate-containing compounds,
component C at least one catalyst,
component D at least one epoxy-functional compound and/or one amino-functional compound,
   for coating components that come into contact with process water in evaporative cooling systems, cooling towers and/or wet separators.

2. Use according to embodiment 1, characterized in that the polyether bearing silyl groups has various repeat units that are prepared by reaction with one or more alkylene oxides, glycidyl ethers, carbon dioxide, cyclic anhydrides, isocyanates, caprolactones or cyclic carbonates or mixtures thereof.

3. Use according to either of the preceding embodiments, characterized in that the polyether bearing silyl groups has one or more terminal and/or one or more pendant alkoxysilyl radicals.

4. Use according to any of the preceding embodiments, characterized in that component B comprises polyethers bearing silyl groups of formula (I):

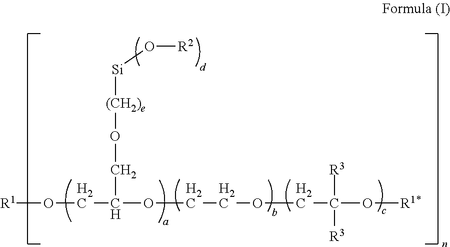

with
a=1 to 10, preferably 2 to 5,
b=1 to 500, preferably 1 to 400, more preferably 1 to 300,
c=1 to 400, more preferably 1 to 300,
d=1 to 3, preferably 3,
e=1 to 10, preferably 1 to 6, more preferably 1 to 3,
with the proviso that the fragments having the indices a, b and c are distributed over the molecule chain in a freely permutable manner and that the sum total of a, b and c is >3,
and where
R¹=a saturated or unsaturated, linear or branched organic hydrocarbon radical which may contain O, S and/or N as heteroatoms, the hydrocarbon radical preferably containing 1 to 400 carbon atoms, preferably 1 to 200 carbon atoms, more preferably 1-20 carbon atoms.
R¹*=hydrogen, a saturated or unsaturated, linear or branched organic hydrocarbon radical which may contain O, S and/or N as heteroatoms, the hydrocarbon radical preferably containing 1 to 400 carbon atoms, preferably 1 to 200 carbon atoms, more preferably 1-20 carbon atoms,
R²=independently at each instance an alkyl group having 1 to 8 carbon atoms, preferably 1 to 5 carbon atoms,
R³=independently at each instance a hydrogen radical or a linear, branched or cyclic alkyl or chloroalkyl group having 1 to 20 carbon atoms, an aryl or alkaryl group, and/or reaction products of a polyether bearing silyl groups of the formula (I) with one or more isocyanate-containing compounds, where R¹* is preferably a hydrogen.

5. Use according to any of the preceding embodiments, characterized in that the polysiloxane is a linear or singly or multiply branched Si—OH— or Si(OR)₃-functional polysiloxane.

6. Use according to any of the preceding embodiments, characterized in that the polysiloxane is an alkoxypolysiloxane.

7. Use according to any of the preceding embodiments, characterized in that component D has a stoichiometric ratio of epoxy function to amino function in the range from 5:0.1 to 0.1:5, preferably of 1:1.5, more preferably of 1:1.

8. Use according to any of the preceding embodiments, characterized in that the epoxy-functional compound comprises epoxy-functional silanes or epoxy-functional siloxanes or aromatic or aliphatic glycidyl ethers or condensates thereof or mixtures thereof.

9. Use according to any of the preceding embodiments, characterized in that the amino-functional compound is an amino-functional alkoxysilane, preferably an amino-functional di- or trialkoxysilane.

10. Use according to any of the preceding embodiments, characterized in that the composition includes at least one crosslinker of the formula (II)

R⁴_{f}Si(OR⁵)_{g} Formula (II)

with the proviso that 0≤f≤2, 0≤g≤4 and f+g=4,
R⁴=independently at each instance an alkyl group or cycloalkyl group having 1 to 8 carbon atoms or an aromatic group having 6 to 20 carbon atoms,
R⁵=independently at each instance an alkyl group having 1 to 8 carbon atoms, preferably a methyl, ethyl, propyl or isopropyl group.

11. Use according to any of the preceding embodiments, characterized in that the catalyst is selected from the group of the catalysts that promote the hydrolysis-condensation mechanism, such as organotin catalysts, titanates or zirconates, organometallic compounds of aluminium, of iron, of calcium, of magnesium, of zinc or bismuth, Lewis acids or organic acids/bases, linear or branched or cyclic amidines, guanidines or amines, or a mixture thereof.

12. Use according to any of the preceding embodiments, characterized in that further additives selected from the group of the plasticizers, fillers, pigments, adhesion promoters, rheology additives, stabilizers, catalysts, solvents and drying agents, especially chemical moisture drying agents, are present in the composition.

13. Use according to any of the preceding embodiments, characterized in that the composition comprises
1% by weight to 85% by weight, preferably 5% by weight to 75% by weight, of component A,
1% by weight to 50% by weight, preferably 10% by weight to 40% by weight, of component B,
0.01% by weight to 5% by weight, preferably 0.05% by weight to 3% by weight, of component C,
   with the proviso that the amounts of components A, B and C add up to 100% by weight, where, based on this amount of 100% by weight of components A, B and C, the composition includes
0.1% by weight to 40% by weight, preferably 10.0% by weight to 35% by weight, of component D.

14. Use according to embodiment 13, characterized in that component D is composed of 5% by weight to 95% by weight, preferably 10% by weight to 80% by weight, more preferably of 20% by weight to 60% by weight, of the epoxy-functional compound and of 0.1% by weight to 50% by weight, preferably 5% by weight to 40% by weight, of the amino-functional compound, based on the composition of component D.

15. Use according to any of the preceding embodiments, characterized in that the formulation is used as hydration additive or coating to the components of evaporative cooling systems, cooling towers and/or wet separators.

16. Use according to any of the preceding embodiments, characterized in that the formulation is applied to the components of evaporative cooling systems, cooling towers and/or wet separators in the form of a spray coating, roller or brush application, curtain coating, dip coating or doctor blade application.

17. Use according to any of the preceding embodiments, characterized in that the formulation is used in an amount of 0.1 g to 1000 g per m², preferably 0.1 g to 500 g per m², more preferably 10 g to 300 g per m², of the area of the components to be coated and per cycle.

18. Use according to any of the preceding embodiments, characterized in that the components are measurement and control units, filters, heat transferrers, packings, spray nozzles, droplet separators, pipelines and cooling tower basins.

19. Use according of the preceding embodiments for improving process water retention and for reducing biofilm formation on components in evaporative cooling systems, cooling towers and/or wet separators.

20. Components of evaporative cooling systems, cooling towers and/or wet separators, characterized in that they have been coated with the formulation according to any of the preceding embodiments.

### BRIEF DESCRIPTION OF THE DRAWINGS

FIG. 1 shows scanning electron micrographs of VZ22 and Z8 coatings under laboratory conditions.

FIG. 2 shows scanning electron micrographs of VZ22 and Z8 coatings in an evaporative cooling system.

### DETAILED DESCRIPTION OF THE INVENTION

Process water in the context of this invention is the water that circulates in an evaporative cooling system for the purpose of heat removal and is in contact with the atmosphere.

Components of evaporative cooling systems, cooling towers and/or wet separators that come into contact with the process water are, for example, measurement and control units, filters, heat transfers, packings, spray nozzles, droplet separators, pipelines and cooling tower basins. The materials of these components may be metals, for example stainless steel, unalloyed steel, low-alloyed steel, aluminium and/or copper, or plastics, for example polyethylene (PE), polyvinylchloride (PVC) and/or polypropylene (PP).

It is assumed that the reduction in biofilm formation is attributable to the anti-adhesive character of the coating according to the invention. On account of this character, deposition of minerals, soil and/or sludge on the surfaces of the coated components of the invention is not possible to the same degree.

In order to avoid deposits on surfaces of components or microbiological contamination, hardness stabilizers, corrosion inhibitors, dispersants and/or oxidizing and/or non-oxidizing biocides are added to the process water in conventional cooling systems.

For hardness stabilization, for example, the following substances are added: inorganic phosphates, organic phosphorus compounds (phosphonic acids, phosphonates), polymeric carboxylates and derivatives thereof, acids (for lowering the acid constant at pH 4.3).

For formation of protective outer layers and hence as corrosion protection for metallic materials, it is possible to add the following groups of substances and mixtures thereof to the process water as corrosion inhibitors: inorganic and organic phosphorus compounds, metal ion-containing inhibitors (zinc compounds, molybdate), specific synthetic inhibitors (e.g. azole derivatives, benzoate), silicates.

For limitation of microbial contamination, it is possible to add oxidizing biocides to the process water, for example inorganic chlorine and bromine compounds, organic chlorine and bromine compounds (halogen eliminators such as bromochlorodimethylhydantoin (BCDMH), monochloroamine, chlorophenol, dichloroisocyanurate), chlorine dioxide, hydrogen peroxide, peracetic acid or ozone, and/or non-oxidizing biocides, for example ammonium salts, glutaraldehyde, organic sulfur compounds (isothiazolinones, tetrakis(hydroxymethyl)phosphonium sulfate (THPS)), organobromine compounds or organochlorine compounds.

In order to support the action of biocides, it is possible to use surface-active substances such as surfactants.

As well as chemical stability to these additives, some of which are quite aggressive, in the process water, it has been found that the formulation comprising curable compositions for coating of the components was additionally suitable for a reduction in biofilm formation. No significant adverse effects were manifested, particularly by oxidative biocides on the coating. This aspect was surprising since EP 3 461 864 did not disclose any pointers at all that the coating produced from the curable composition is resistant to biocides.

The reduction in biofilm formation additionally also has the advantage that the reproduction of pathogens, for instance Legionella, is reduced. Legionella are not capable of producing the essential amino acid cysteine themselves, and hence never occur in the environment as a pure culture, but are instead always accompanied by other microorganisms in the biofilm. Furthermore, Legionella have a long generation time compared to other microbes pathogenic to humans, and so it can be assumed that the occurrence of Legionella, to an extensive degree in some cases, in the process water can be attributed solely to the detached bacteria in the biofilm. Reduction in biofilm formation thus also reduces the risk of settlement and reproduction of Legionella in the biofilm. This likewise reduces the introduction of Legionella into the process water and hence ultimately also the release of Legionella in aerosols. It should be noted here that no biocidal action has been detected in coatings produced with the formulation according to the invention comprising curable compositions.

A further important parameter for the operation of evaporative cooling systems, cooling towers and/or wet separators is also the dwell time of the process water on packings that assure intensive contact between water and air.

In the case of the packings, a distinction is made between water film-forming internals and water droplet-forming internals.

Water film-forming internals usually consist of moulded polymer films of polypropylene or PVC that are bonded or welded to form assemblies. The shape of the films makes a large area available for heat and mass transfer, while the air is guided in counter- or crosscurrent through the channels that form. With film internals, it is possible to achieve high performance density.

Water droplet-forming internals, for example trickle grids or drip grilles, are encountered in various geometric arrangements and materials. Here too, air is guided in a countercurrent or crosscurrent arrangement.

The cooling effect of evaporative cooling systems, cooling towers and/or wet separators is therefore dependent on the dwell time of the warm process water on the internals. It is thus possible to even better exploit the cooling effect resulting from the evaporation of the process water.

By virtue of the coating with the formulation according to the invention, it was possible to find, entirely unexpectedly, that the process water dwells for longer on the packings. It is therefore possible to conclude, conversely, that the coating of such components that has been produced with the formulation according to the invention comprising curable compositions increases retention capacity compared to internals that have not been coated with a formulation comprising curable compositions.

It is assumed that the longer the process water is able to dwell on the packings, the more intensive the contact between water and air is, and, accordingly, the cooling effect can be improved.

Specified in detail hereinafter is a preferred curable composition that can be used for the use according to the invention.

Preferably, the polyether bearing silyl groups has various repeat units that are prepared by reaction with one or more alkylene oxides, glycidyl ethers, carbon dioxide, cyclic anhydrides, isocyanates, caprolactones or cyclic carbonates or mixtures thereof.

Advantageously, the polyether bearing silyl groups has one or more terminal and/or one or more pendant alkoxysilyl radicals.

Preferably, component B comprises polyethers bearing silyl groups of formula (I):

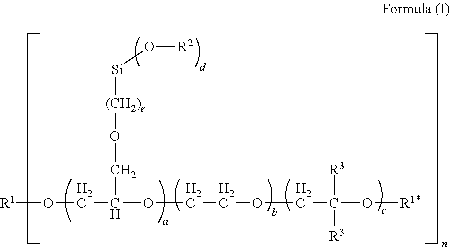

with
a=1 to 10, preferably 2 to 5,
b=1 to 500, preferably 1 to 400, more preferably 1 to 300,
c=1 to 400, more preferably 1 to 300,
d=1 to 3, preferably 3,
e=1 to 10, preferably 1 to 6, more preferably 1 to 3,
with the proviso that the fragments having the indices a, b and c are distributed over the molecule chain in a freely permutable manner and that the sum total of a, b and c is >3, and where

R¹=a saturated or unsaturated, linear or branched organic hydrocarbon radical which may contain O, S and/or N as heteroatoms, the hydrocarbon radical preferably containing 1 to 400 carbon atoms, preferably 1 to 200 carbon atoms, more preferably 1-20 carbon atoms,

R¹′=hydrogen, a saturated or unsaturated, linear or branched organic hydrocarbon radical which may contain O, S and/or N as heteroatoms, the hydrocarbon radical preferably containing 1 to 400 carbon atoms, preferably 1 to 200 carbon atoms, more preferably 1-20 carbon atoms,
R²=independently at each instance an alkyl group having 1 to 8 carbon atoms, preferably 1 to 5 carbon atoms,
R³=independently at each instance a hydrogen radical or a linear, branched or cyclic alkyl or chloroalkyl group having 1 to 20 carbon atoms, an aryl or alkaryl group,

and/or reaction products of a polyether bearing silyl groups of the formula (I) with one or more isocyanate-containing compounds, where R¹* is preferably a hydrogen.

Preferably, the polysiloxane is a linear or singly or multiply branched Si—OH— or Si(OR)₃— functional polysiloxane.

The polysiloxane is preferably an alkoxypolysiloxane.

Preferably, component D may also contain a polysiloxane having at least one epoxy functionality and/or one alkoxy functionality.

Preferably, component D has a stoichiometric ratio of epoxy function to amino function in the range from 5:0.1 to 0.1:5, preferably 1:1.5, more preferably 1:1.

The epoxy-functional compound preferably comprises epoxy-functional silanes or epoxy-functional siloxanes or aromatic or aliphatic glycidyl ethers or condensates thereof or mixtures thereof.

Preferably, the amino-functional compound is an amino-functional alkoxysilane, preferably an amino-functional di- or trialkoxysilane.

Preferably, the composition includes at least one crosslinker of the formula (II)

R⁴_{f}Si(OR⁵)_{g} Formula (II)

with the proviso that 0≤5f≤2, 0≤g≤4 and f+g=4,

R⁴=independently at each instance an alkyl group or cycloalkyl group having 1 to 8 carbon atoms or an aromatic group having 6 to 20 carbon atoms,

R⁵=independently at each instance an alkyl group having 1 to 8 carbon atoms, preferably a methyl, ethyl, propyl or isopropyl group.

The catalyst is preferably selected from the group of catalysts that promote the hydrolysis condensation mechanism, such as organotin catalysts, titanates or zirconates, organometallic compounds of aluminium, iron, calcium, magnesium, zinc or bismuth, Lewis acids or organic acids/bases, linear or branched or cyclic amidines, guanidines or amines or a mixture thereof.

In addition, the formulation may comprise further additives selected from the group of the plasticizers, fillers, pigments, adhesion promoters, rheology additives, stabilizers, catalysts, solvents and drying agents, especially chemical moisture drying agents.

For the use according to the invention, the composition preferably includes
1% by weight 85%, by weight, preferably 5% by weight to 75% by weight, of component A;
1% by weight to 50% by weight, preferably 10% by weight to 40% by weight, of component B,
0.01% by weight to 5% by weight, preferably 0.05% by weight to 3% by weight, of component C,

with the proviso that the amounts of components A, B and C add up to 100% by weight, where, based on this amount of 100% by weight of components A, B and C, the composition includes
0.1% by weight to 40% by weight, preferably 10.0% by weight to 3% by weight, of component D.

Preferably, component D is composed of 5% by weight to 95% by weight, preferably 10% by weight to 80% by weight, more preferably of 20% by weight to 60% by weight, of the epoxy-functional compound and of 0.1% by weight to 50% by weight, preferably 5% by weight to 40% by weight, of the amino-functional compound, based on the composition of component D.

Where chemical (empirical) formulae are used in the present invention, the specified indices can be not only absolute numbers but also average values.

For polymeric compounds, the indices preferably represent average values.

Unless otherwise stated, percentages are in per cent by weight.

If measured values are reported hereinbelow, these measurements, unless stated otherwise, have been conducted under standard conditions (25° C. and 1013 mbar).

Where average values are given hereinbelow, the values concerned are weight averages, unless otherwise stated.

For preparation of the curable composition, reference is made to EP 3 461 864, preferably Example 1.

The composition or formulation applied to the components cures with ingress of air humidity via a catalysed hydrolysis-condensation crosslinking process. Combined forced drying at elevated temperature and accompanying chemical crosslinking via hydrolysis-condensation with introduction of sufficient moisture into the oven are not mutually exclusive, and this depends to a crucial degree on the substrate to be coated.

Preferably, the formulation is used as hydration additive or coating for components of evaporative cooling systems, cooling towers and/or wet separators.

The formulation is preferably applied to the components of evaporative cooling systems, cooling towers and/or wet separators in the form of a spray coating, roller or brush application, curtain coating, dip coating or doctor blade application.

It is also advantageous to subject the surface of the components to be coated to various pretreatments. From the prior art, surfaces can be pretreated in various ways.

Just a few shall be mentioned here:

Metal surfaces are typically provided with corrosion protection. For this purpose, what are called primers are used, for example zinc dust primers, anticorrosion primers.

In order to assure adhesion between substrate and effective topcoat layer, it is possible, for example, to use primers, for example epoxy primers, vinyl primers, or to apply tiecoats based, for example, on silicone or silicone resin binders. Adhesion can also be improved by employing thin-layer methods. Mention may be made here, for example, of pretreatment with silanes and solvents, fluorination, flame treatment, corona treatment, plasma treatment and electron beam treatment.

Preference is given to using the formulation in an amount of 0.1 g to 1000 g per m², preferably 0.1 g to 500 g per m², more preferably 10 g to 300 g per m², of the area of the components to be coated and per cycle.

The components are preferably heat transferrers, packings, spray nozzles, droplet separators, pipelines and cooling tower basins.

The invention thus also provides for the use of the formulation comprising curable compositions as described for improving process water retention and for reducing biofilm formation on components in evaporative cooling systems, cooling towers and/or wet separators.

The invention further provides components of evaporative cooling systems, cooling towers and/or wet separators that have been coated with the formulation comprising curable compositions.

The subject matter of the invention is described by way of example hereinbelow, without any intention that the invention be restricted to these illustrative embodiments.

### Methods

### Application

The binder composition is generally applied by spray application, but can also be applied by other application techniques, for example knife coating, painting, rolling, flow coating, dipping, casting. Suitable substrates include metallic substrates, for example steel, cast steel, stainless steel, aluminium, cast aluminium or hot dip galvanized steel. For improved adhesion, the substrate may be roughened by sandblasting or sanding. Nonmetallic substrates such as glass, plastics, or inorganic substrates such as ceramics, stoneware, concrete etc., may also be employed.

The binder composition according to the invention that is applied to the substrate then cures with ingress of air humidity via a catalysed hydrolysis-condensation crosslinking process. Combined forced drying at elevated temperature and accompanying chemical crosslinking through hydrolysis-condensation with introduction of sufficient moisture into the oven are not mutually exclusive.

A further advantage of hydrolysis-condensation coating systems with an added catalyst is that they are not subject to any pot life problems in the case of closed containers, since the curing does not take place until water from the surrounding air humidity is present. In contrast to the conventional, purely physically drying coating systems, for example silicone resin-based systems, which must first be baked at substrate temperatures of 250° C. for at least 30 minutes in order to achieve their full mechanical and chemical stability, a complete saving can be made here on the oven drying energy.

The appearance of the coating was assessed. The surface should form a continuous, homogeneous film. Any paint defects, such as craters, pinholes, edge thinning or the like, should be listed, Surface quality is likewise assessed visually. This is done by assessing the roughness of the paint film.

### Further Conditions

Where values are expressed in % in the context of the present invention, these are % by weight values unless otherwise stated. In the case of compositions or formulations, values in % are based on the entire composition or entire formulation unless otherwise stated. Where averages are reported hereinafter, these are number averages unless stated otherwise. Where measured values are reported hereinbelow, these measurements, unless stated otherwise, were determined at a pressure of 101 325 Pa, a temperature of 23° C. and the ambient relative humidity of approx. 40%.

### 1. Production of the Formulation and Application

### 1.1 Production of the Curable Composition

TABLE 1
Materials used for the curable composition according to EP 3 461 864

| | | | | Methoxy | |
|---|---|---|---|---|---|
| | | | Phenyl/methyl | value (% | Molecular weight |
| | | Type and source | ratio (Ph:Me) | by wt.) | (Mw = kg/mol) |
| Component A | | | | | |
| A3 | Polysiloxane | 3074 Intermediate, from Dow | 1:1 | 15-18 | ~01.3 |
| | | Corning | | | |
| Component B | | | | | |
| B3 | | Preparation of B3 according to EP | | | |
| | | 3 461 864 | | | |
| Component C | Catalyst | TibKat 318 (DBTL), from TIB | | | |
| | | Mannheim with CAS No, 68299-15-0 | | | |
| Component D. analogous to Table 2 of EP 3 461 864 | | | | | |
| D1 | α,ω-Epoxypropoxypropyl- | DMS-E12, CAS No. 102782-97-8, | | | |
| | functional polydimethylsiloxane | Gelest | | | |
| D2 | Epoxy resin | Eponex Resin 1510, Hexon | | | |
| D3 | Arninopropyltriethoxy lane | Dynasylan ArVIEO, CAS No. 919- | | | |
| | | 30-2, Evonik | | | |

TABLE 2

| | | VZ22 | Z8 | VZ25 | Z9 |
|---|---|---|---|---|---|
| Component A | A3 | 70 | 70 | 70 | 70 |
| Component B | B3 | | 30 | | 30 |
| Component C | Catalyst* | 2 | 2 | 2 | 2 |
| Component D | D1 | 30 | 30 | | |
| | D2 | | | 30 | 30 |
| | D3** | 1:0.95 | 1:0.95 | 1:0.95 | 1:0.95 |

The FIGURES are given as parts by weight, except that
*component C is reported in % by weight based on the overall
composition and
**the amount of component D3 is calculated by means of
the ratio of D1 or D2 in accordance with the molar ratio specified.

The production of the curable composition Z8 and Z9 and comparative composition VZ22 and VZ25 according to the details from Table 2 is conducted according to EP 3 461 864, Example 1.

After a short period at rest of 5 minutes, the inventive compositions and comparative compositions, for assessment of the film properties, were drawn down by means of a 300 μm bar applicator (300 μm bar applicator, from Simex) at RT onto isopropanol-cleaned glass plates (from Gläserei Glänzer, dimensions: 90×150×5 mm) and dried at RT; to determine the drying time, they were applied to standard glass strips (30×2.5 cm×2 mm) by means of a bar applicator (from Erichsen Model 360, wet film thickness 100 μm). In addition. PVC panels (200×400×5 mm, cat. no.:4364002858, KVG Kunststoff Betriebs GmbH) previously pretreated with a commercial primer (Sika Poxicolor Primer HE NEU) for better adhesion were coated by spray application. Finally, drying was carried out for 24 hours at RT in drying cabinets intended therefor.

All samples showed good to very good visual filming capacity, as set out in Table 7 of EP 3 461 864.

### 1.2 Production of Pigmented Formulations from the Curable Compositions

The pigmented formulations according to Table 3 were produced by means of a Dispermat CN-40F2 from VMA Getzmann using a jacketed 1 I steel grinding vessel from Getzmann. A Teflon disc of diameter 50 mm was utilized. The curable compositions and the solvent were weighed in and stirred. Glass beads of diameter 2.4-2.9 mm were added. Subsequently, pigments and fillers were additionally weighed in and predispersed at a speed of 21 m/s for 15 minutes. In the course of this, the temperature should not exceed 60° C. Further solvent was added, and the main dispersion was conducted at 25 m/s for 30 min. In the course of this, the temperature should not exceed 60° C., Lastly, butyldiglycol was added as levelling aid.

TABLE 3

| Raw material | Function | Manufacturer | PL-VZ22 | PL-Z8 | PL-VZ25 | PL-Z9 |
|---|---|---|---|---|---|---|
| V222 binder | Binder | | 50.00 | | | |
| 18 binder | Binder | | | 50 | | |
| V225 binder | Binder | | | | 50 | |
| Z9 hinder | Binder | | | | | 50 |
| TEGO ® Dispers 670 | Dispersing | Evonik | 5.00 | 5.00 | 5.00 | 5.00 |
| | additive | Industries | | | | |
| TEGO ® Foamex 810 | Defoamer | Evonik | 1.00 | 1.00 | 1.00 | 1.00 |
| | | Industries | | | | |
| Solvesso 100 | Solvent | ExxonMobil | 4.00 | 4.00 | 4.00 | 4.00 |
| initial charging and | | | | | | |
| stirring | | | | | | |
| AEROSIL ® 200 | Thickener | Evonik | 2.00 | 2.00 | 2.00 | 2.00 |
| | | Industries | | | | |
| FINNTALC M15 | Filler | Elementis | 10.00 | 10.00 | 10.00 | 10.00 |
| BAYFERROX ® 130M | Pigment | LANXESS | 5.00 | 5.00 | 5.00 | 5.00 |
| Kronos 2310 | Pigment | Kronos | 7 00 | 7.00 | 7.00 | 7.00 |
| | | International | | | | |
| BLANC FIXE micro | Filler | Solvay | 6.00 | 6.00 | 6.00 | 6.00 |
| Predispersion | | | | | | |
| Xylene | Solvent | various | 8.00 | 8.00 | 8.00 | 8.00 |
| Main dispersion | | | | | | |
| Butyldiglycol | Levelling aid | various | 2.00 | 2.00 | 2.00 | 2.00 |
| Total | | | 100.00 | 100.00 | 100.00 | 100.00 |
| D3 | | | 1:0.95 | 1:0.95 | 1:0.95 | 1:0.95 |

### 1.2.1 Application of Pigmented and Unpigmented Formulations

Application of the formulations produced under 1.2 was accomplished by the following methods:

Dip application for coating of both sides of small PVC or metal coupons (2.5 cm×7.5 cm) for the bioassay as described below, and the exposures in the cooling tower

### 2. Bioassay

For testing of the formulations comprising curable compositions with regard to their efficacy for prevention or at least for reduction of biofilms under laboratory conditions, coatings VZ22, Z8, VZ25, Z9 and PL-VZ22, PL-Z8, PL-VZ-25 and PL-Z9 were applied to 2.5 cm×7.5 cm PVC coupons, analogously to the manner described above.

Reference organisms used for the bacterial suspension were drinking water bacteria.
Production of the bacterial suspension stock solution

The bacteria were the autochthonous microflora that formed from drinking water with addition of casein soya flour peptone (CASO) broth (30 g/l of sterile drinking water, from Merck KGaA Millipore) at 30° C. within 16±1 hours. The total cell titre of this bacterial suspension stock solution was determined by microscopy with the aid of a counting chamber (Thoma-neu, from Lo-Laboroptik Ltd.)
Production of the bacterial suspension working solution

The bacterial suspension stock solution was diluted such that a cell count of 5×10⁶ cells/ml was present in 1.8 l of CASO broth in a dilution of 1:10 (1.5 g/l of sterile drinking water).

### 2.1 Determination of the Efficacy of the Coating According to the Invention for Reduction of Biofilm Formation under Laboratory Conditions

The bacterial suspension working solution produced in this way was introduced into a 2 l beaker that in each case contained 12 coated PVC coupons (VZ22, Z8, VZ25, Z9, PL-VZ22, PL-Z8, PL-VZ25, PL-Z9) fixed vertically by a steel ring with clamps. In the middle was a magnetic stirrer bar that mixed the bacterial suspension working solution. The beaker stood on a magnetic hotplate set such that the bacterial suspension working solution was at a temperature of 30° C.

The coated glass microscope slides were removed after 7 days. The coated PVC coupons were then examined for biofilm formation thereon. The visual assessment was made using a scanning electron microscope (Tabletop™ 4000Plus, Hitachi Ltd.).

The control reference used was uncoated PVC coupons. All samples and references were tested in triplicate.

The overall assessment was made visually by means of a scale as shown below of

0=no biofilm; inference→very good anti-adhesive properties
1=minimal biofilm; inference→very good anti-adhesive properties
2=slight biofilm; inference→good anti-adhesive properties
3=moderate biofilm; inference→moderate anti-adhesive properties
4=significant biofilm; inference→poor anti-adhesive properties

The visual assessment of the samples with regard to biofilm formation was performed by microscope and is described in Table 5.

TABLE 5
Visual assessment of biofilm formation
under laboratory conditions

| Coating | Assessment |
|---|---|
| VZ22 | 4 |
| Z8 | 1 |
| VZ25 | 4 |
| Z9 | 3 |
| PL-VZ22 | 4 |
| PL-Z8 | 2 |
| PL-VZ25 | 4 |
| PL-Z9 | 3 |
| Control reference | 4 |

All formulations according to the invention have lower film formation across the board than the corresponding comparative examples. It is therefore also possible to conclude that the anti-adhesive character of the coatings according to the invention is better than that of the comparative examples.

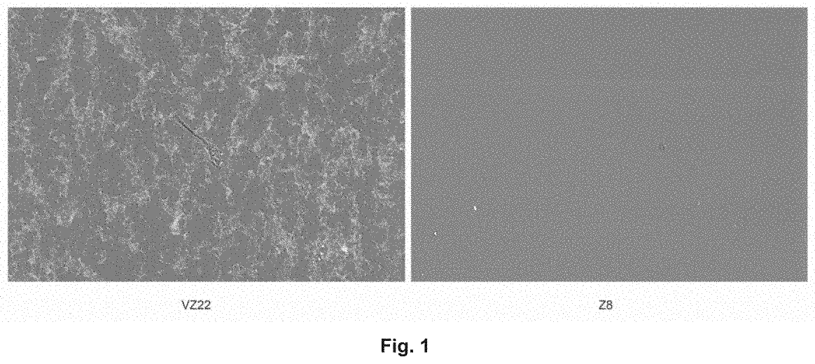

FIG. 1 shows, for example, scanning electron micrographs of VZ22 and Z8. The biofilm of VZ22 is clearly apparent. Z8 has no biofilm.

### 2.2 Determination of the Efficacy of the Coating according to the Invention for Reduction of Biofilm Formation in an Evaporative Cooling System

The PVC coupons VZ22, Z8; VZ25; Z9 and PL-VZ22, PL-Z8, PL-VZ-25 and PL-Z9 coated on both sides with the respective formulation comprising curable compositions were exposed, in the packings, to the environment of an evaporative cooling system for a total of 12 weeks.

As control reference, uncoated PVC coupons were likewise exposed to the environment of the evaporative cooling system for a total of 12 weeks. The samples in triplicate were removed after 12 weeks and tested for biofilm formation. The visual assessment was made using a scanning electron microscope (Tabletop™ 4000Plus, Hitachi Ltd.).

The overall assessment was effected by means of a scale as shown below of

0=no biofilm; inference→very good anti-adhesive properties

1=minimal biofilm; inference→very good anti-adhesive properties

2=slight biofilm; inference→good anti-adhesive properties

3=moderate biofilm; inference→moderate anti-adhesive properties

4=significant biofilm; inference→poor anti-adhesive properties

TABLE 6
Visual assessment of biofilm formation
in an evaporative cooling system

| Coating | Assessment |
|---|---|
| VZ22 | 4 |
| Z8 | 2 |
| VZ25 | 4 |
| Z9 | 3 |
| PL-VZ22 | 4 |
| PL-Z8 | 3 |
| PL-VZ25 | 4 |
| PL-Z9 | 3 |
| Control reference | 4 |

Even under real conditions, the coatings according to the invention have barely any biofilm. Thus, the conclusion that the coatings according to the invention have better anti-adhesive character is justified.

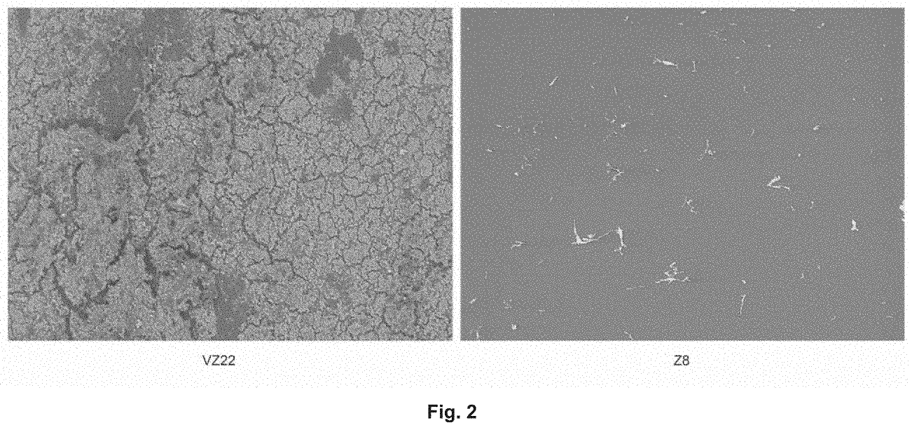

FIG. 2 shows, for example, scanning electron micrographs of VZ22 and Z8. The biofilm of VZ22 is clearly apparent. Z8 has only very little biofilm.

### 2.3 Determination of Legionella

Since the coating surface Z8 showed the best performance in the exposure test in the evaporative cooling system, Z8 was tested with regard to the occurrence of Legionella spec. compared to the control reference (PVC).

The samples in triplicate were removed after 2, 4 and 6 weeks and examined as follows:

The growth on the sample surfaces after testing in the evaporative cooling system was scraped off and analysed for the occurrence of Legionella spec. The growth that had been scraped off was diluted logarithmically according to ISO 11731:2017, and plated out onto glycine vancomycin polymyxin cycloheximide (GVPC) nutrient agar plates. The samples were incubated at 36° C. for 7 days. Subsequently, the colony-forming units (CFU) were quantified. The occurrence of Legionella spec, was calculated in CFU/cm². A detection limit of 1 CFU/cm² applied.

The CFU/cm² ascertained on Z8 and the control reference (PVC) are shown in Table 7.

TABLE 7
Detection of Legionella spec.

| | Legionella spec. CFU cm2 | | |
|---|---|---|---|
| Coating | 2 weeks | 4 weeks | 6 weeks |
| Z8 | n.s. | n.s. | 6.67E+00 |
| Control reference | n.s. | 6.67E+01 | 1.80E+01 |

The analysis of the growth on the sample surfaces for the occurrence of Legionella spec. showed that less Legionella had formed on coating Z8 than the control reference (PVC). After 4 weeks, the evaporative cooling system was disinfected on account of the Legionella contamination on the control reference. The last few samples were left in the system and were removed and analysed after a further 2 weeks. Even after 6 weeks, Z8 showed lower contamination by Legionella spec. than the control reference.

It is thus evident that the use according to the invention does not have any biocidal effect since slight growth could be detected.

### 3. Testing of Retention Capacity

Coated and uncoated packing units in a size of 15×20 cm made of PVC were set up at an angle of 45°. A domestic water spray bottle with a spray head was used to spray water three times onto the upper portion of the PVC test specimens. The time until the droplets had run off completely was measured.

TABLE 7

| | | Time until run- |
|---|---|---|
| | Sample | off [s = second] |
| VR | PVC uncoated | 2 s |
| R1 | PVC coated with formulation Z8 | 90 s |
| R2 | PVC coated with formulation Z8 | 110 s |
| | after exposure to water for 3 h | |

The coated packing units have a distinctly greater water-retaining effect than the uncoated packing unit, both on first contact with water and in the course of use if the coating is constantly moistened.

On account of this improved water-retaining effect, the cooling effect can be exploited even more efficiently.

1. A method for coating a component that contacts process water in an evaporative cooling system, cooling tower, and/or wet separator, the method comprising:
applying a formulation comprising a curable composition to the component, wherein the curable composition comprises
a component A comprising at least one polysiloxane,
a component B comprising at least one polyether bearing silyl groups and/or reaction products of a polyether bearing silyl groups with one or more isocyanate-containing compounds,
a component C comprising at least one catalyst, and
a component D comprising at least one epoxy-functional compound and/or one amino-functional compound.

2. The method according to claim 1, wherein the at least one polyether bearing silyl groups, if present, has various repeat units that are prepared by reaction with one or more alkylene oxides, glycidyl ethers, carbon dioxide, cyclic anhydrides, isocyanates, caprolactones, cyclic carbonates, or mixtures thereof.

3. The method according to claim 1, wherein the at least one polyether bearing silyl groups has one or more terminal and/or pendant alkoxysilyl radicals.

4. The method according to claim 1, wherein component B comprises at least one polyether bearing silyl groups of formula (I): 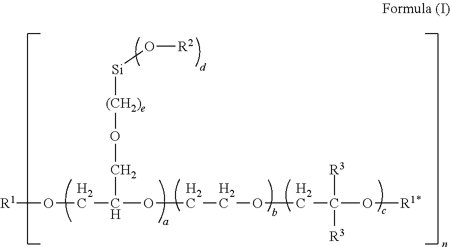
with
a=1 to 10,
b=1 to 500,
c=1 to 400,
d=1 to 3,
e=1 to 10,
with the proviso that fragments having the indices a, b, and c are distributed over the molecule chain in a freely permutable manner and a sum total of a, b, and c is >3, and wherein
R¹=a saturated or unsaturated, linear or branched organic hydrocarbon radical which may contain O, S, and/or N as heteroatoms,
R¹=hydrogen, or a saturated or unsaturated, linear or branched organic hydrocarbon radical which may contain O, S, and/or N as heteroatoms,
R²=independently at each instance an alkyl group having 1 to 8 carbon atoms,
R³=independently at each instance a hydrogen radical or a linear, branched, or cyclic alkyl or chloroalkyl group having 1 to 20 carbon atoms, an aryl or alkaryl group, and/or a reaction product of a polyether bearing silyl groups of the formula (I) with one or more isocyanate-containing compounds.

5. The method according to claim 1, wherein the at least one polysiloxane is a linear or singly or multiply branched Si—OH— or Si(OR)₃-functional polysiloxane.

6. The method according to claim 1, wherein the at least one polysiloxane is an alkoxypolysiloxane.

7. The method according to claim 1, wherein component D has a stoichiometric ratio of epoxy function to amino function in the range from 5:0.1 to 0.1:5.

8. The method according to claim 1, wherein the at least one epoxy-functional compound, if present, comprises an epoxy-functional silane, an epoxy-functional siloxane, an aromatic or aliphatic glycidyl ether, a condensate thereof, or a mixture thereof.

9. The method according to claim 1, wherein the amino-functional compound, if present, is an amino-functional alkoxysilane.

10. The method according to claim 1, wherein the composition includes at least one crosslinker of the formula (II)
R⁴_{f}Si(OR⁵)_{g} Formula (II)
with the proviso that 0≤f≤2, 0≤g≤4, and f+g=4,
R⁴=independently at each instance an alkyl group or cycloalkyl group having 1 to 8 carbon atoms or an aromatic group having 6 to 20 carbon atoms,
R⁵=independently at each instance an alkyl group having 1 to 8 carbon atoms.

11. The method according to claim 1, wherein the at least one catalyst is selected from the group consisting of a catalyst that promotes a hydrolysis-condensation mechanism, a titanate, a zirconate, an organometallic compound of aluminium, an organometallic compound of iron, an organometallic compound of calcium, an organometallic compound of magnesium, an organometallic compound of zinc, an organometallic compound of bismuth, a Lewis acid, an organic acid, an organic base, a linear amidine, a branched amidine, a cyclic amidine, a guanidine, an amine, and a mixture thereof.

12. The method according to claim 1, wherein the composition comprises a further additive selected from the group consisting of a plasticizer, filler, pigment, adhesion promoter, rheology additive, stabilizer, catalyst, solvent, and drying agent.

13. The method according to claim 1, wherein the composition comprises:
1% by weight to 85% by weight of component A,
1% by weight to 50% by weight of component B,
0.01% by weight to 5% by weight of component C,
with the proviso that the amounts of components A, B, and C add up to 100% by weight, where, based on this amount of 100% by weight of components A, B, and C, the composition includes 0.1% by weight to 40% by weight of component D.

14. The method according to claim 13, wherein component D is composed of 5% by weight to 95% by weight of the epoxy-functional compound and of 0.1% by weight to 50% by weight of the amino-functional compound, based on the composition of component D.

15. The method according to claim 1, wherein the formulation is a hydration additive or coating for the component.

16. The method according to claim 1, wherein the formulation is applied to the component in the form of a spray coating, roller or brush application, curtain coating, dip coating, or doctor blade application.

17. The method according to claim 1, wherein the formulation is applied in an amount of 0.1 g to 1000 g per m² of an area of the component to be coated and per cycle.

18. The method according to claim 1, wherein the component is a measurement unit, a control unit, a filter, a heat transferrer, a packing, a spray nozzle, a droplet separator, a pipeline, or a cooling tower basin.

19. A method for improving process water retention and for reducing biofilm formation on a component in an evaporative cooling system, cooling tower, and/or wet separator, the method comprising:
coating the component according to the method of claim 1.

20. A component of an evaporative cooling system, cooling tower, and/or wet separator, wherein the component is coated according to the method of claim 1.
